(19) United States
(12) Patent Application Publication
(10) Pub. No.: US 2009/0251751 A1
(43) Pub. Date: Oct. 8, 2009

(54) Optical Imaging System

(76) Inventor: Kurt Kuhlmann, San Jose, CA (US)

Correspondence Address: Zarian Midgley & Johnson PLLC, University Plaza, 960 Broadway Ave., Suite 250, Boise, ID, 83706, US

(21) Appl. No.: 12/061,485

(22) Filed: Apr. 2, 2008

(51) Int. Cl. G02B 21/06; G02B 5/02; G02B 5/32

(52) U.S. Cl. 359/15; 359/385; 359/599; 359/30

(57) ABSTRACT

An illumination device for an optical imaging apparatus, such as a microscope. The illumination of a slide specimen is achieved when divergent light for a point light source or a plurality of point light sources illuminate the specimen converging at high angles at equal brightness across all angles. The user of divergent light cancels the cosine distributed gradient effect (Lambert's cosine law) to effectively create a substantially evenly distribution of light. The placement of diffractive or diffusive film under the specimen causes the light to converge at high angles onto the specimen. The light from the point light source can be further diffused by passing it through a column having its interior coated with a non-diffractive material adapted to widely scatter the light.

### BACKGROUND

The present application relates to optical microscopy and in particular to the illumination design for an optical system and methods of use thereof.

Modern microscope systems require sophisticated illumination in order to perform properly. What is desired is not only smooth and even illumination, but that the light is projected through the imaged sample at steep angles where the intensity of light at every angle through the sample also must be constant, otherwise optical artifacts can be created. Sophisticated illumination is very difficult and has historically been achieved with Koehler or critical illumination, discussed below.

Various considerations must be taken into account when developing optical systems for microscopy, such as the numerical aperture (“NA”) of an optical system, which is a dimensionless number that characterizes the range of angles over which the system can accept or emit light. In microscopy, NA is important as it indicates the resolving power of a lens. Thus, a lens with a larger NA will be able to visualize finer details than a lens with a smaller NA.

Another consideration is the Lambertian Pattern that is generated from the light source. In an ideal Lambertian Pattern, the light is scattered such that the apparent brightness of the surface to an observer is the same regardless of the observer's angle of view. It is known that the Lambertian pattern of a light emitting diode (“LED”) concentrates most of the light out the front of the LED resulting in sort of a parabolic dispersion pattern.

Another factor when developing optical systems for microscopy is the critical illumination. The configuration of the illumination in a microscope may include a source of the illumination, such as a lamp, focused by a condenser onto the specimen on a slide. This configuration can result in un-even illumination of the specimen if there are spatial variations in the lamp.

Still other factors to consider are the effects of using a diffuser through which light passes in order to uniformly illuminate the sample in the microscope and the isotropic pattern of transmitted light exhibiting properties, such as density of light transmission, with the same values when measured along axes in all directions.

Conventional optical microscope systems generally utilize a Koehler illumination system which uses a series of precise lenses and reflectors to control the redirection of light into an ideal evenly illuminated field of view with light converging on the specimen isotropically in all directions. Koehler illumination utilizes a collector lens in front of the light source that focuses the light at the condenser diaphragm, which has the effect of putting the condenser diaphragm and the filament image in conjugate planes. Thus, the filament image is no longer conjugate to the image plane, and is no longer visible. However, these systems require substantial space, expensive optics and often require a skilled technician to configure the microscope though the precise adjustment and alignment of the reflectors and lenses.

There are some public domain products like the Richardson field microscope that use crude diffused light in lieu of a condenser, but this is just ordinary diffused glass or plastic. This configuration does not carefully illuminate nor does it evenly emit light over wide dispersion angles. As such, it performs poorly as compared to a configuration using a real condenser.

The prior art techniques, such as those depicted in FIGS. 5-7, illustrate various optic illumination arrangements, such as using condenser lenses along with a necessary light source to project a specimen image to an eyepiece for viewing. Other typical prior art techniques seek to diffuse light through numerous scattering methods. Most methods attempt a random pattern generation using Opal diffuser plates to generate a Lambertian Pattern of spatially even isotropic light on the specimen. However, Opal diffuser plates are expensive.

Point source lights require a system to separate the light rays, normally done by a lens, so the light rays can converge again upon the specimen. Filament based lamps must overcome the projection of the filament onto the specimen through optical lens direction of the light and/or diffusion techniques. As discussed above, ideal illumination of a slide specimen may be achieved when light illuminates the specimen converging at high angles at equal brightness across all angles. A spatially isotropic light source is often created with precise lenses to control the redirection of light from the light source. However, such lighting systems are expensive and generally have a long adjustable path between lenses to control the angular pitch of the light making it difficult to achieve miniaturization of the light source. LED light sources lend themselves to lens based redirection because they are nearly point light sources.

Modern LEDs can provide very bright white light with low heat, but as identified above, are nearly point light sources. When diffused, modern LEDs generate light scattering from the center out, as shown in FIG. 4. In an ideal illumination pattern, light is scattered isotropically in all directions with a constant level of illumination across the specimen, including outside in. Scattering light isotropically allows for complete and even illumination of the specimen.

Surface-emitting LEDs create a resulting pattern of light at an intensity proportional to the cosine of the emission angle relative to the normal. The area directly above the LED is the most brightly illuminated and the edge being the least illuminated with the amount of illumination changing with the cosine of the angle. This kind of light distribution, if used directly, creates a very poor illumination pattern because the light is not evenly distributed through desired angles and spatial density.

There are numerous configurations used in an attempt to provide adequate illumination of a specimen for microscopy. For example, U.S. Pat. No. 5,734,498 (“the '498 patent”) discloses the user of fluorescent spherical particles to scatter and/or re-emit light in more directions. The disclosed configuration depends on the diffuser to take a wide angle light preferably from a lamp with a wide light source surface area. The invention disclosed in the '498 patent teaches the use of a “perfect” diffuser that can take low angle light and bend it over the entire ideal range. “Perfect” diffusers that are able to take low angle light and bend it over the entire ideal range are expensive.

U.S. Pat. No. 6,963,445 (“the '445 patent”) discloses using a diffuser plate with a standard light source. The '445 patent discloses a method of creating convergent spatially isotropic light by eliminating the condenser of a Koehler lighting system with a diffusive film. However, the '445 patent discloses the use of standard light sources, which does not provide highly angular light without the use of lenses. The '445 patent does not disclose how a point light source could be used with the disclosed configuration to create ideal illumination of a specimen.

The prior art techniques for producing adequate illumination of a specimen for an optical imaging systems are very expensive. Known low cost configurations generally provide poor illumination of the specimen with limitations and disadvantages discussed above. Further, the prior art optical imaging systems do not teach the adequate illumination of a specimen using point light sources, such as LEDs. There is a need for a low cost method of illuminating a specimen to be examined on the stage of an optical microscope. Further, there is a need for a low cost configuration that provides ideal illumination of a specimen using point light sources.

### SUMMARY

In one embodiment an illumination arrangement for an optical imaging apparatus, such as a microscope, is disclosed wherein ideal illumination of a slide specimen is achieved using a light point source, such as an LED or a plurality of LEDs, in combination with diffuser film. The light point sources may be positioned in a pattern that emits divergent light at high angles and at equal brightness across all angles that effectively cancels the cosine distributed gradient effect (“Lambert's cosine law”) as shown in FIG. 4. A diffractive or diffusive film may be used to converge the divergent light at high angles onto the specimen creating a substantially ideal isotropic light distribution on the specimen. The light from the light point sources can be further diffused by passing it through a column having its interior coated with a coating adapted to widely scatter the light.

### BRIEF DESCRIPTION OF THE DRAWINGS

FIG. 1A and FIG. 1B illustrate one embodiment of a lighting system having a plurality of surface-emitting LEDs arranged with respect to a diffractive film to provide ideal Lambertian light distribution on a specimen.

FIG. 2A and FIG. 2B illustrate one embodiment of a lighting system having a plurality of surface-emitting LEDs arranged with respect to a column having a diffractive non-transparent interior surface and a diffractive or diffusive film above it to provide ideal Lambertian light distribution on a specimen.

FIG. 3 illustrates one embodiment of a lighting system having an edge-emitting LED arrange with respect to a column having a diffractive non-transparent interior surface and a diffractive or diffusive film to provide ideal Lambertian light distribution on a specimen.

FIG. 4 is an illustrative example of a Lambertian Illumination Pattern.

FIG. 5-FIG. 7 illustrate various prior art Microscope Lighting Systems.

### DETAILED DESCRIPTION

An illumination device for an optical imaging apparatus, such as a microscope, illumination of a slide specimen is achieved when light illuminates the specimen converging at high angles at equal brightness across all angles by utilizing divergent light in an arrangement that helps cancels the cosine distributed gradient effect to effectively create a substantially even distribution of light. The light is then made to converge at high angles onto the specimen by using a diffractive or diffusive film located below the specimen slide. Additionally, the light can be further diffused by passing it through a column having its interior coated in order to widely scatter the light.

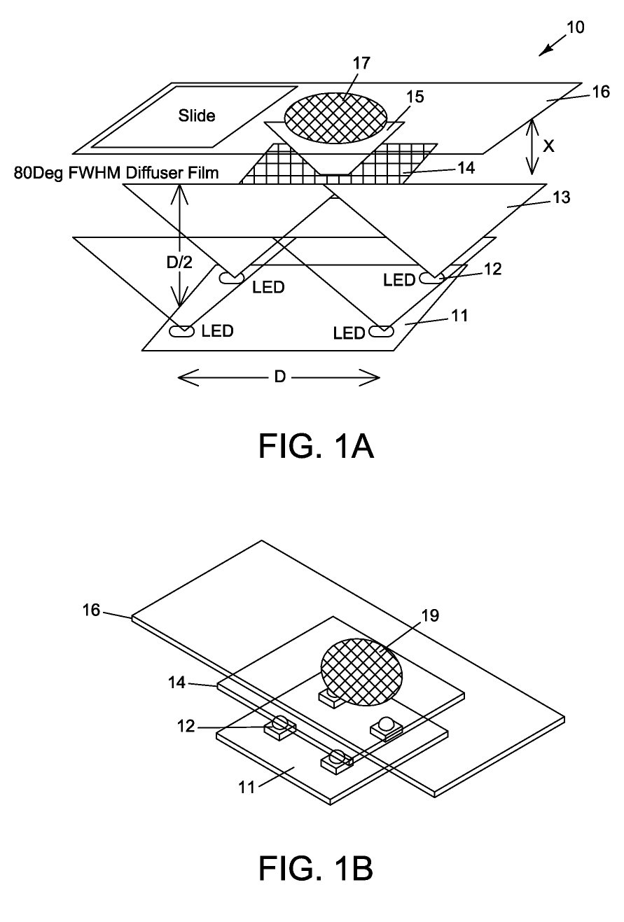

FIG. 1A shows an embodiment where diffractive or diffusive film is affixed a short distance below a microscope slide and the film is illuminated from below by a LED or an array of LEDs so that the slide sample or specimen to be imaged is illuminated evenly across its width and through all angles, or in other words, has a high NA. The film causes the light from the LED or array of LEDs to converge at high angles onto the specimen. The film used to converge the light may be a holographic wide angle diffuser film. With the advent of holographic and diffractive films, it is possible to approximate this style of illumination with a diffractive film located just behind the slide in lieu of a full condenser system.

Referring now to FIG. 1A and FIG. 1B, an illumination assembly 10 comprises a light source, such as an LED array assembly 11 having at least one LED, but preferably having multiple LEDs 12 mounted thereon spaced apart by distance D. As an example, four (4) individual LEDs 12 are set spaced apart by distance D on the plane of the LED array assembly 11. The number of LEDs and configuration of the LEDs is for illustrative purposes only. One of ordinary skill in the art having the benefit of this disclosure would appreciate that various configurations of LEDs could be used to provide emitted light having high angles at equal brightness across all angles. A diffusive or diffractive film is used to converge the light emitted from the array of LEDs. For example, a holographic wide angle diffuser film 14, such as a diffractive optic based diffuser film, is placed above and over the LED array assembly 11 and beneath a microscope slide plate 16. An area of spatially isotropic light pattern 15 is created to illuminate the microscope slide plate 16 as the light emitted from the LEDs, shown as the light emission pattern 13, diffuses through diffuser film 14 into the underside of the slide plate 16 to create an illumination disk 17 that penetrates into the specimen sample 19 resident in slide plate 16. The light emission pattern 15 (and ultimately depicted by illumination disk 17) generates a highly uniform pattern having an almost ideal Lambertian distribution. With the specimen sample 19 on the slide plate 16, such as a transparent slide plate, is placed over the disk of light 17, the almost ideal Lambertian light distribution uniformly illuminates the specimen 19 for evaluation.

For illustrative purposes only, an implementation of the embodiment illustrated in FIG. 1A that provides a uniform illumination of a specimen is as follows. For example, such as when using a shop microscope fixed for a standard slide and having the depth described of 1″ and therefore a film size of 0.62″ area diameter one needs to use a film with even diffraction over at least a 72° angle. The film must be large and close enough to the sample to project light into the sample at large angles.

For instance to achieve 0.95 NA for the configuration shown in FIG. 1A, the light needs to enter from 0° (normal to the slide underside) up to 72°. Modern microscope objectives at 40× need this high of a NA to perform to the limits of their resolving power. To have light enter up to 72°, the film must evenly diffract over this angle and if located a distance “X” below the slide sample, the illumination disk must be at least 2×(tan(72°)) in diameter. For instance, if the film is 0.1″ away from the sample (1.5 mm beneath a 1 mm thick slide), then the illumination disk needs to be 0.62″ in diameter to achieve 0.95 NA.

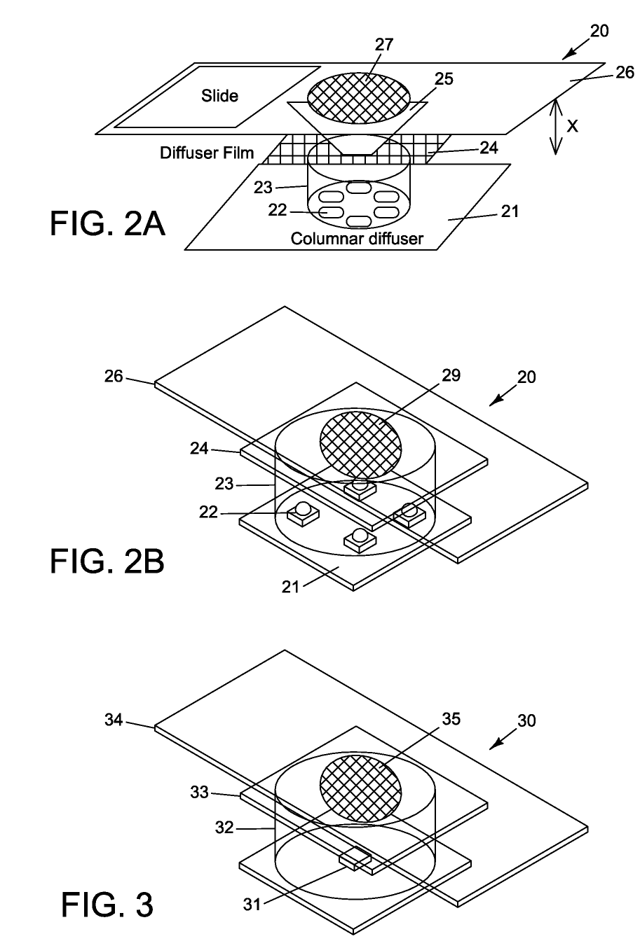

FIG. 2A and FIG. 2B depict an illustration of another embodiment where a means to produce high numerical aperture (i.e., 0.95 NA) illumination is to use a ring illumination with a columnar diffuser placed over a light source(s) and located beneath a diffuser film.

Referring now to FIG. 2A and FIG. 2B, an illumination assembly 20 comprises a light source, such as an LED array assembly 21 having at least one LED, but preferably having multiple LEDs 22 mounted thereon and placed in a circular pattern thereabout. The LED array assembly 21 is further enclosed by a columnar diffuser 23. A diffuser film 24, such as a diffractive optic based diffuser film, is placed above the columnar diffuser 23 (and ultimately over the LED array assembly 21) and beneath a slide plate 26. A light emission pattern 25 is created as light from the LED array assembly 21 bounces off the sides of the columnar diffuser 23 and into the underside of the diffuser film 24 at steep angles. The film 24 then diffracts the light pattern into the underside of the slide plate 26 to create an illumination disk 27 having a highly uniform pattern that is with an almost ideal spatially isotropic distribution.

The columnar diffuser 23 may be coated with a non-diffractive material adapted to widely scatter the light. An example of a plating material for the columnar diffuser 23 would be titanium dioxide which can be applied in a matte white finish that is highly diffusive. The LED array assembly 21 in the perimeter pattern such that the light combines into an evenly distributed pattern that can pass across the interior surface of a columnar diffuser coated with a light scattering finish. The light is finally passed through a light diffusing film to generate high angle light deflection even distributed onto the specimen 29. Perfect diffusers do not exist that function as ideal isotropic radiators, all will preferentially forward scatter and/or backscatter light. The light diffused at grazing angles, the high frequency component referred to in Fourier optics, is at a much lower intensity.

Light can also be generated from edge emitting LEDs that are located on a reflective surface. Light from the edge emitting LEDs pass through a light scattering columnar diffuser finally to pass through a diffusive film onto the specimen. Even the best of these films though only have 80° FWHM (Full-Width Half-Maximum) performance, meaning that 40° off of normal the intensity of the light is already decreased by half. The edge emitting LED allows for even higher angles to be generated starting at the source and permits the use of one (or more if it does not emit at all edges) LED as the light source.

FIG. 3 illustrates one embodiment of an illumination system 30 having an edge-emitting LED 31 arrange with respect to a column 32 that has a diffractive non-transparent interior surface. Above the column is a diffractive or diffusive film 33 to further diffuse the light to provide an ideal light distribution on a specimen 35 on the slide 34.

The embodiments of FIG. 1A, FIG. 2A, and FIG. 3 use a diffuser film that is positioned a short distance below a microscope slide. The film is illuminated from below by a LED or an array of LEDs so that the slide sample to be imaged is illuminated evenly across its width and through all angles, (referred to as high NA) in order to achieve good illumination. The diffuse film may be a holographic wide angle diffuse film.

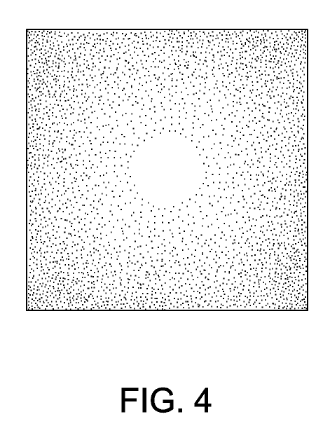

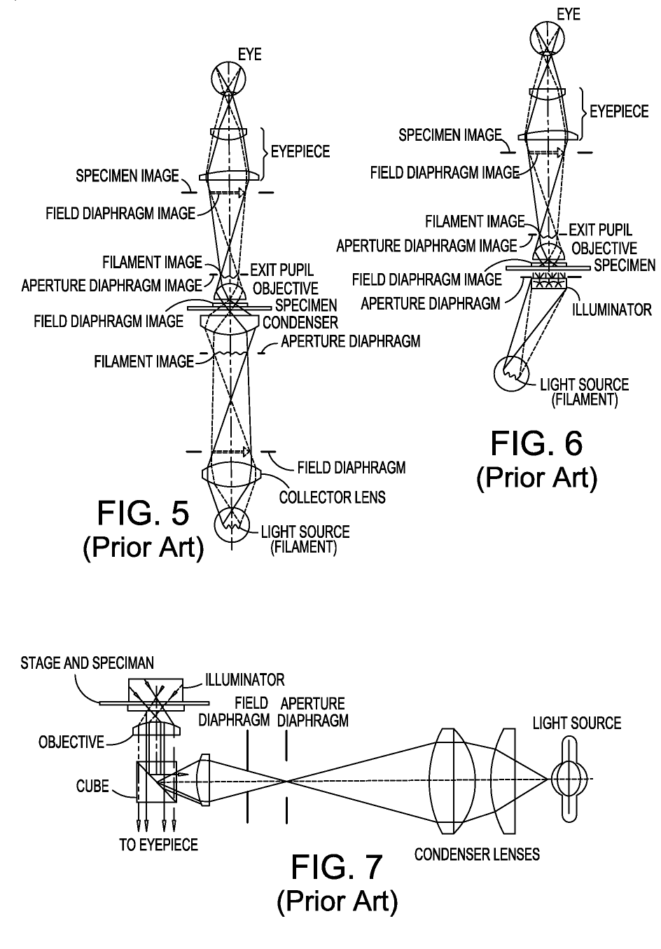

In one embodiment, the diffuser film is very evenly illuminated from below, such as by an ultra-bright high efficiency LED. Any small size illumination source like a bulb or LED tends to have a Lambertian pattern where the intensity varies as cosine of the angle off normal as shown in FIG. 4. So any single, centered light source will have intensity drop-off at the edges of the film. In order to compensate, one can create an array of Lambertian emitters in the form of LEDs, which if carefully placed, will create almost flat field illumination over the entire diffuser film. The LED array is designed such that the individual Lambertian light cones superpose to create an almost constant, even illumination to the underside of the film. The even light over a broad area means this illumination system does not need to be centered or adjusted for different objectives as do Koehler systems. This means the illumination system of the system disclosed herein can also be used with a macro or thumbnail camera.

The various embodiments described above overcome disadvantages of point source lighting nature of LEDs and at the same time take advantage of the predictable illumination pattern through use of a diffractive film and selective arrangement of the LEDs to the size and location of the diffractive film. Another advantage is that each embodiment allows for low cost manufacturing of an optical imaging apparatus, such as a high powered oil immersion microscope and the like. Another advantage is that it brings the light in at steep angles. With other systems, a deficit of high angle light results in some component of the image being high resolution but yet dimly lit, while another low resolution image is superimposed over the best image because of shallow angle light and is dominant. The system described above takes advantage of the Lambertian Emission pattern of LEDs by arranging them in a pattern that has a canceling affect on the illumination pattern and introducing high angles to otherwise direct point source light. The high angle is accentuated and the light further randomized and therefore mixed through an even wider range of angles and illumination. The resulting pattern is highly regular and provides almost ideal spatially isotropic distribution.

Although this invention has been disclosed in the context of certain embodiments and examples, it will be understood by those skilled in the art having the benefit of this disclosure that the present invention extends beyond the specifically disclosed embodiments to other alternative embodiments and/or uses of the invention and obvious modifications and equivalents thereof.

What is claimed is:

1. An optical imaging system comprising:
a film affixed a distance from a slide, the film being illuminated from an imposing direction by at least one LED such that a slide sample to be imaged receives even illumination across its width and through a range of angles defined by a numerical aperture of the optical imaging system.

2. The optical imaging system of claim 1, wherein the film is a diffractive film.

3. The optical imaging system of claim 1, wherein the film is a diffuser film.

4. The optical imaging system of claim 3, wherein the film is a holographic wide angle diffuser film.

5. The optical imaging system of claim 1 further comprising an array of LEDs, wherein said LED array is designed such that individual Lambertian light cones superpose to create substantially constant, even illumination to an underside of a holographic wide angle diffuser film.

6. The optical imaging system of claim 1, wherein said film is illuminated by the at least one LED covered by a columnar diffuser.

7. The optical imaging system of claim 6, wherein the at least one LED is a side-emitting LED placed on a reflective surface.

8. The optical imaging system of claim 6, wherein an interior surface of the columnar diffuser a non-diffractive material adapted to widely scatter the light from the at least one LED.

9. The optical imaging system of claim 8, wherein the non-diffractive material is titanium dioxide.

10. The optical imaging system of claim 1, wherein said numerical aperture is at least 0.95.

11. A method of optical imaging comprising:
affixing a wide angle diffuser film a distance from a microscope slide, wherein the wide angle diffuser film is positioned between the microscope slide and an LED or array of LEDs;
emitting light from the LED or the array of LEDs, wherein the emission of light generates a substantially even illumination from the diffuser film;
illuminating the microscope slide with the substantially even illumination across a specified width and through a range of angles as defined by a numerical aperture of an optical system employed with said wide angle diffuser film.

12. The method of claim 11, wherein the wide angle diffuser film comprises holographic wide angle diffuser film.

13. The method of claim 11, wherein said LED array is designed such that individual Lambertian light cones superpose to create substantially constant, even illumination to the wide angle diffuser film.

14. The method of claim 11, wherein said wide angle diffuser film is illuminated by ring illumination from an LED or array of LEDs covered by a columnar diffuser, wherein a slide sample to be imaged is illuminated evenly across its width and through the range of angles.

15. The method of claim 14, wherein the ring illumination is produced from at least one side emitting LED placed on a reflective surface with the columnar diffuser placed thereover.

16. The method of claim 14, wherein the columnar diffuser is adapted to bounce light off and into an underside of the wide angle diffuser film.

17. The method of claim 11, wherein the numerical aperture is at least 0.95.

18. The method of claim 17, wherein said numerical aperture of at least 0.95 is obtained by light entering from 0° to 72° normal to an underside portion of said slide sample.

19. The method of claim 11, wherein even illumination eliminates a requirement for said optical system to be centered or adjusted for different slide samples.
